(19) United States
(12) Patent Application Publication
(10) Pub. No.: US 2024/0008600 A1
(43) Pub. Date: Jan. 11, 2024

(54) Band-Connector

(71) Applicant: Google LLC, Mountain View, CA (US)

(72) Inventors: Wee Phurn Lim, Singapore (SG); Nick Gillett, San Francisco, CA (US); Laura Shumaker, Sunnyvale, CA (US); Sheng-Chieh Lin, Taipei City (TW)

(21) Appl. No.: 18/036,309

(22) PCT Filed: Nov. 12, 2020
(86) PCT No.: PCT/US2020/060225

§ 371 Date: May 10, 2023

(51) Int. Cl. A44C 5/14; A44C 5/00; B29C 45/14

(52) U.S. Cl. CPC A44C 5/14; A44C 5/0053; B29C 45/14467; B29L 2031/739

(57) ABSTRACT

A band having a first portion comprising a plurality of fibers, a second portion extending from an end of the first portion, the second portion having a thick section and a thin section, and a first component encompassing the thick section and a portion of the thin section.

### BACKGROUND

Attaching flexible textiles to rigid assemblies requires a number of considerations to be balanced. For example, the connector that facilitates the connection between a textile watch strap and a watch case requires the ends of the textile strap to have a certain level of rigidity as well as precisely located connection features, such as holes, for an even distribution of force. Improper connector designs can result in high stress concentrations along the end of the watch strip, thus leading to an increased risk of failure on those concentration points.

However, creating a stronger connector must be balanced against the complexity and cost of manufacturing. Such an increase in manufacturing complexity and cost can render a connector design commercially infeasible. For example, increasing the strength of the connector may require parts that have higher, and more difficult to achieve, precision requirements while still maintaining a low profile. Additionally or alternatively, more components may be required in the connector design, thus increasing the chances that at least one part of the connector may be improperly manufactured or fitted together. Moreover, the increase in components may increase the chances the components will have dissimilar material compositions, may decrease the ease or likelihood of being able to recycle the connector, and may increase the risk of delamination or detachment of the various components.

### BRIEF SUMMARY

In one aspect of the disclosure, a band comprises a first portion comprising a plurality of fibers, a second portion extending from an end of the first portion, the second portion having a thick section and a thin section, and a first component encompassing the thick section and a portion of the thin section. The first portion may have a non-uniform cross-section. The first portion and the second portion may be a same material. The second portion further may include a film having a same material as the first portion. The thin section may extend from the end of the first portion. The thick section may define a plurality of holes along a length of the thick section. The band may further comprise a second component encompassing the first component. The first component may include a protrusion extending in a direction substantially perpendicular to a longitudinal axis defined by the band. The second portion may define a first hole and the first component defines a second hole, the first hole being concentric with the second hole. The second component may be configured to be engaged with a lug of a watch case.

In another aspect of the disclosure, a method for forming a connector on a band comprises compressing an end of the band to construct a formed end portion of the band, the formed end portion having a thick section and a thin section, and injecting a first component over the thick section and a portion of the thin section. The method may further comprise heating the end of the band. The method may further comprise cutting off an excess portion of the formed end portion such that the formed end portion has a curved shape. Forming the formed end portion may include forming the thin section extending from an unformed portion of the band. Forming the formed end portion may include forming the thick section extending from the thin section. The method may further comprise injecting a second component over the first component. The method may further comprise ensuring alignment over a protrusion extending from the formed end portion. The method may further comprise cutting a first hole in the formed end portion and a second hole in the first component, aligning the first hole and the second hole, and injecting a portion of the second component into the first hole and the second hole. The method may further comprise laying a film over the end of the band. Compressing the end of the band may include compressing the film over the formed end portion.

### BRIEF DESCRIPTION OF THE DRAWINGS

FIG. 1 is an isometric view of a band connector in accordance with aspects of the disclosure.

FIG. 2 is a cross-sectional view of the band connector of FIG. 1.

FIG. 3 is an isometric view of a woven band of the band connector of FIG. 1.

FIG. 4 is a cross-sectional view of the woven band of FIG. 3.

FIG. 5 is an isometric view of a first molded component of the band connector of FIG. 1.

FIG. 6 is an isometric view of the first molded component of FIG. 5.

FIG. 7 is a profile view of the first molded component of FIG. 5.

FIG. 8 is a top view of the first molded component of FIG. 5.

FIG. 9 is an isometric view of the first molded component and the woven band of FIG. 1.

FIG. 10 is a cross-sectional view of the first molded component and the woven band of FIG. 1.

FIG. 11 is an isometric view of the second molded component of the band connector of FIG. 1.

FIG. 12 is an isometric view of the second molded component of FIG. 11.

FIG. 13 is a top view of the second molded component of FIG. 11.

FIG. 14 is a profile view of the second molded component of FIG. 11.

FIG. 15 is a side view of the second molded component of FIG. 11.

FIG. 16 is a schematic illustration of a watch in accordance with aspects of the disclosure.

FIG. 17 is an example flowchart of the method of manufacturing a band connector in accordance with aspects of the disclosure.

### DETAILED DESCRIPTION

This technology is directed to a woven band connector and methods of manufacturing thereof. A woven band can be formed such that the end of the woven band has a geometry and material composition that enables a more secure connection between the woven band and components of the woven band connector. A component is molded over the end of the woven band to form a connector, which can be used, for example, to connect the woven band to a watch.

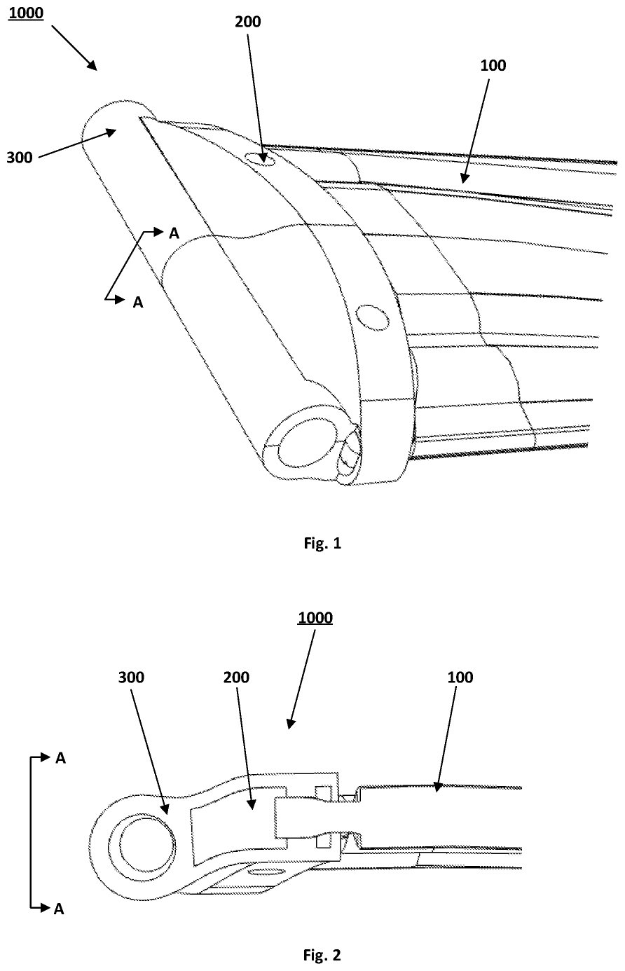

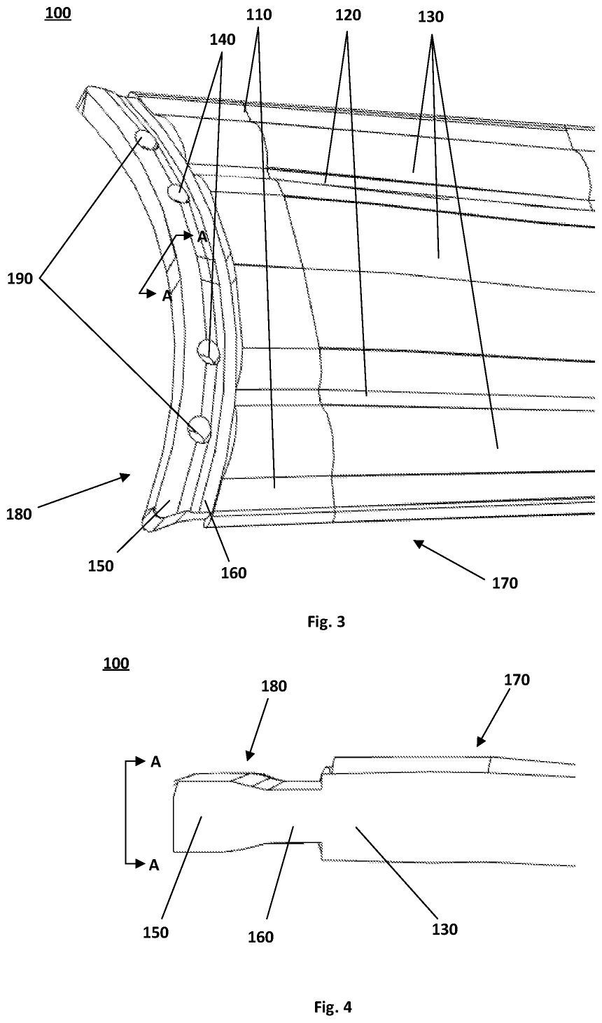

FIG. 1 depicts a band connector 1000 made of an end portion of a woven band 100, a first component 200, and a second component 300. FIG. 2 depicts a cross-sectional view of cross-section A-A of band connector 1000. The first component 200 can be overmolded on the end portion of the woven band 100 and the second component 300 can be overmolded on the first molded component. Although the following disclosure describes having both first component 200 and second component 300 overmolded on the end portion of the woven band, in other examples, only one molded component may be overmolded over the end portion of woven band 100, such as only second component 300.

FIG. 3 depicts woven band 100 having an unformed portion 170 and a formed end portion 180. FIG. 3 depicts a cross-sectional view of cross-section A-A of woven band 100. Formed end portion 180 can be formed from unformed portion 170. In this regard, formed end portion 180 may be formed by, for example, compressing or heating the end of unformed portion 170.

Both the unformed portion 170 and formed end portion 180 may be constructed from substantially the same material. In this regard, the woven band 100, including unformed portion 170 and formed end portion 180 can be made of multiple textile fibers. Woven band 100 can be formed from a plastic that is capable of being melted from pressure, such as polyester, nylon, polypropylene, or other thermoplastics. First component 200 and second component 300 can be formed from a polymer, such as polycarbonate, acrylonitrile butadiene styrene (ABS) or thermoplastics that match woven band 100, or first component 200 may be a metal, such as aluminum or stainless steel.

The woven band 100 can have a consistent and/or variable cross-sectional area along a width. As depicted in FIG. 3, unformed portion 170 includes boundary portions 110, intermediate portions 120, and raised portions 130. Boundary portions 110 define the width of woven band 100 while intermediate portions 120 and raised portions 130 are particular weave patterns woven into the woven band between the boundary portions in an alternating sequence. Raised portions 130 have a thicker cross-sectional area relative to intermediate portions 120. For instance, raised portions 130 can have an oblong cross-sectional geometry while intermediate portions 120 can have a rectangular intermediate geometry. However, in other examples, the cross-sectional areas of woven band 100 can have any geometry, such as rectangular, triangular, round, or the like. Each of boundary portions 110, intermediate portions 120, and raised portions 130 can be the same or different types of woven patterns, formed of the same or different combinations of yarns.

In other examples, the woven band 100 can have more or fewer types of woven patterns, or a variety of types of warp and weft yarns, than depicted in FIG. 3. For instance, the woven band 100 can have just one type of woven pattern, warp and weft yarn, and fabric such that unformed portion 170 is essentially just one portion having a substantially uniform cross-sectional area. Alternatively, the woven band 100 can have greater than three portions 110, 120, 130. Depending on the combination of yarns, and/or woven patterns used to construct portions 110, 120, 130, a variety, or consistency, of textures and fabrics can be provided to a wearer of the woven band 100.

Formed end portion 180 includes a thick section 150 and a thin section 160. Thick section 150 has a larger cross-sectional area than thin section 160 along a length of woven band 100, as depicted in FIG. 4. Additional components can be manufactured to engage with formed end portion 180 by encompassing thick section 150 and a portion of thin section 160. In other examples, formed end portion 180 can have a substantially uniform cross-sectional area along a length of woven band 100.

Formed end portion 180 includes a sloping portion between thick section 150 and thin section 160. This sloping portion allows for a consistent transition from thick section 150 to thin section 160. In other examples, the transition portion between thick section 150 and thin section 160 can have any shape, such as being a sharp corner, being rounded, or the like. Alternatively, there may be no transition portion.

Formed end portion 180 is substantially curved along both a height and a width of woven band 100, as further illustrated in FIG. 3. The curved shape of formed end portion 180 can be designed to match the shape of the watch body (not shown). In other examples, formed end portion 180 can be any other shape, such as straight, angled, etc., or any combination of shapes.

Formed end portion 180 defines holes 140, 190 along a portion of thick section 150, as well as the transition portion between the thick section and thin section 160. Holes 140, 190 can allow for a tool, such as an injection molding tool, to more accurately and securely engage with formed end portion 180. For instance, an injection molding tool can engage holes 190 and inject a portion of a component, such as first component 200, overmolded over the formed end portion into holes 140. In other examples, holes 140, 190 may have any other shape, such as rectangular, triangular, or the like. Moreover, in yet other examples, formed end portion 180 may have more or less than four holes 140, 190, such as having no holes. In yet other examples, holes may be formed in thin section 160. In yet further examples, holes 140, 190 can be defined only along thick section 150, without any overlap with the transition portion.

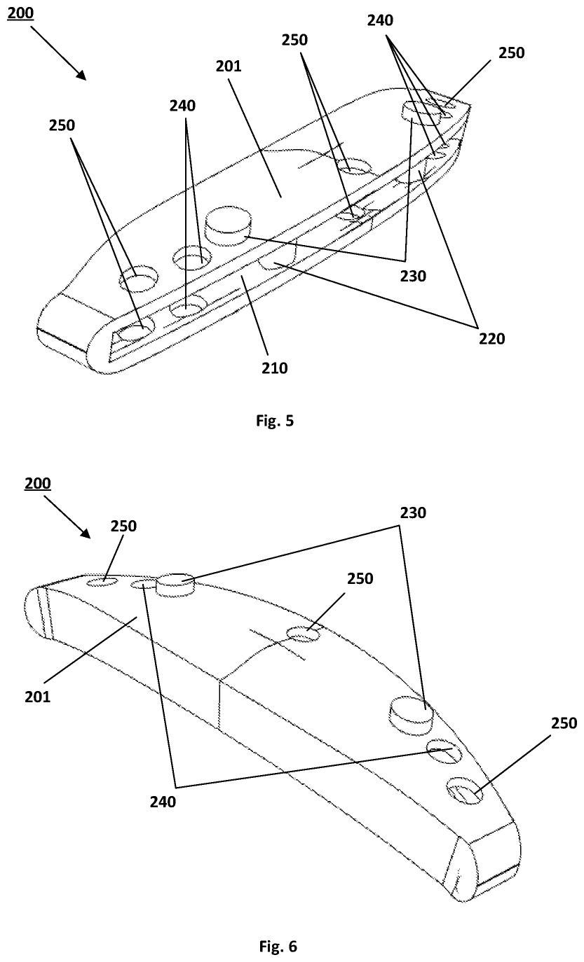

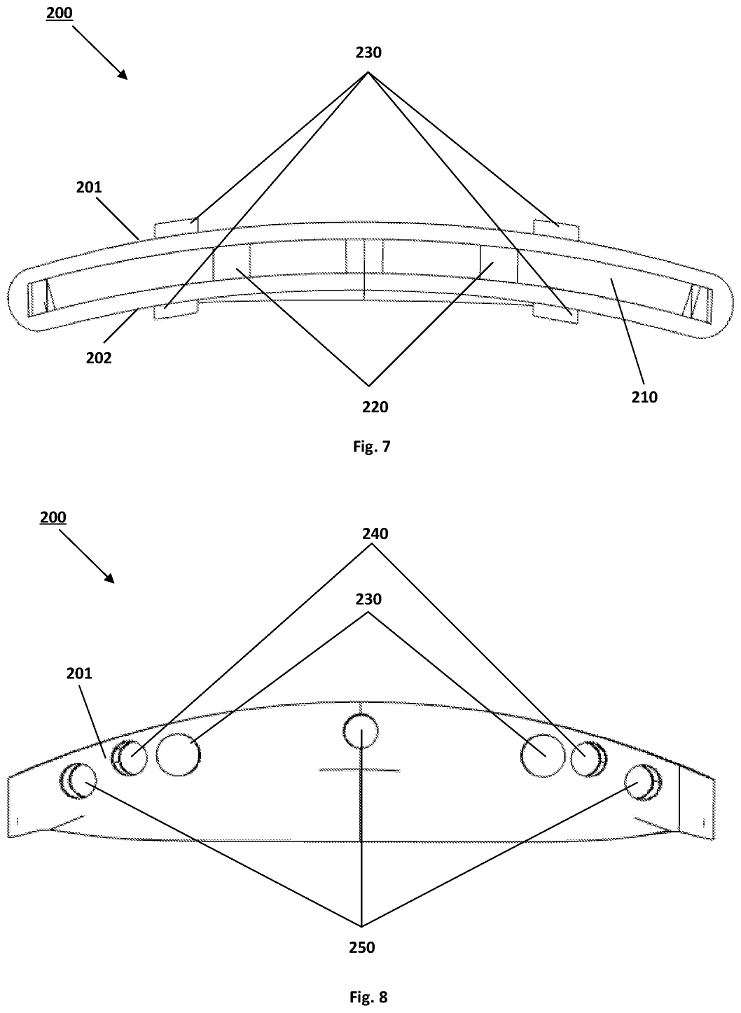

FIGS. 5-8 depict first component 200 including columns 220 and pins 230, and defining a plurality of holes 240, 250 and cavity 210. First component 200 has a slightly curved shape. This curved shape can correspond to the curved shape of formed end portion 180. Similarly, in other examples, first component 200 can have any other shape, such as being substantially straight, angled, or the like. Cavity 210 can be configured to encompass a portion of formed end portion 180 by being overmolded over the formed end portion, as described further below.

Columns 220 are substantially cylindrical and extends from a top surface to bottom surface of cavity 210. Columns 220 can be received within formed end portion 180 through holes 140. Such an engagement between columns 220 and formed end portion 180 can provide a stronger connection between first component 200 and woven band 100. In other examples, there may be more or fewer than two columns 220, such as no columns, three columns, four columns, etc. Moreover, columns 220 can have a non-cylindrical shape, such as rectangular, triangular, or the like.

Pins 230 extend from a top and bottom surface of first component 200. Pins 230 can enable a more accurate and secure engagement between first component 200 and a tool during the manufacturing of band connector 1000, such as an injection molding tool. Although pins 230 are depicted as being substantially cylindrical, in other examples there pins 230 may have any other shape, such as rectangular, triangular, or the like. Moreover, in other examples, there may be more or less than four pins 230, such as three pins or five pins.

Holes 240, 250 are defined by first component 200 through a top surface 201 and bottom surface 202 of the first component. Holes 240 can be concentrically aligned with holes 190. Such an alignment can allow for a portion of an additional component, such as second component 300, to be injection molded through first component 200 and formed end portion 180 so that woven band 100 can be more securely engaged with the first and additional component. Holes 250 can enable a more accurate and secure engagement between first component 200 and a tool during the manufacturing of band connector 1000. Similar to holes 240, holes 250 can also enable a portion of a component to engage with first component 200 to ensure a more secure fit, such as extensions 330 of second component 300. In other examples, holes 240, 250 may have any other shape, such as rectangular, triangular, or the like. Moreover, in yet other examples, the top and bottom surfaces of first component 200 may have more or less than four holes 240, 250, such as having no holes. Further, holes 240, 250 can be formed on only one of a top or bottom surface of first component 200.

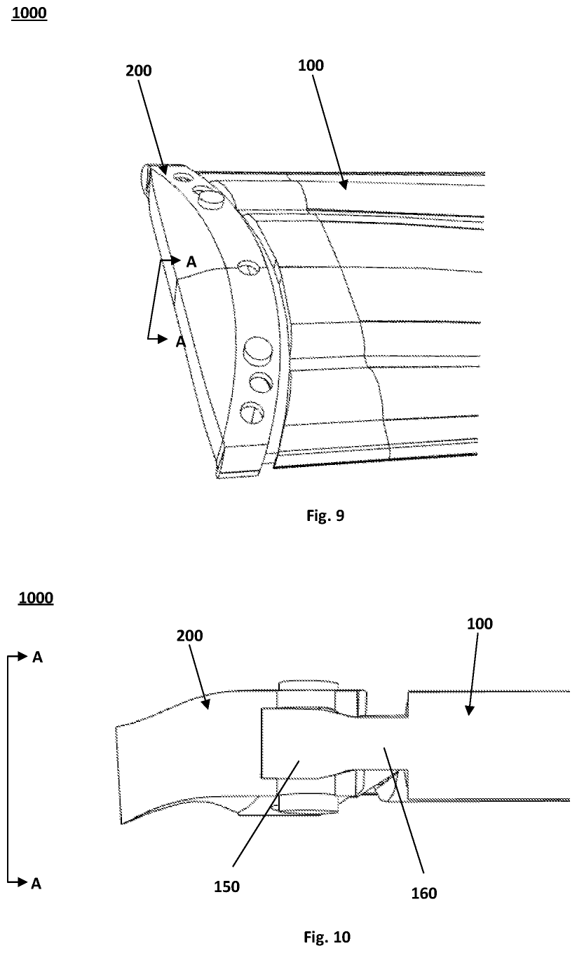

FIG. 9 depicts first component 200 overmolded over thick section 150 and a portion of thin section 160 such that the entirety of the thick section is encompassed by cavity 210. FIG. 10 depicts a cross-sectional view of cross-section A-A of first component 200 overmolded over woven band 100. This engagement between first component 200 and woven band 100 can minimize movement between the two components, and can maximize force transmission between the first component and the woven band.

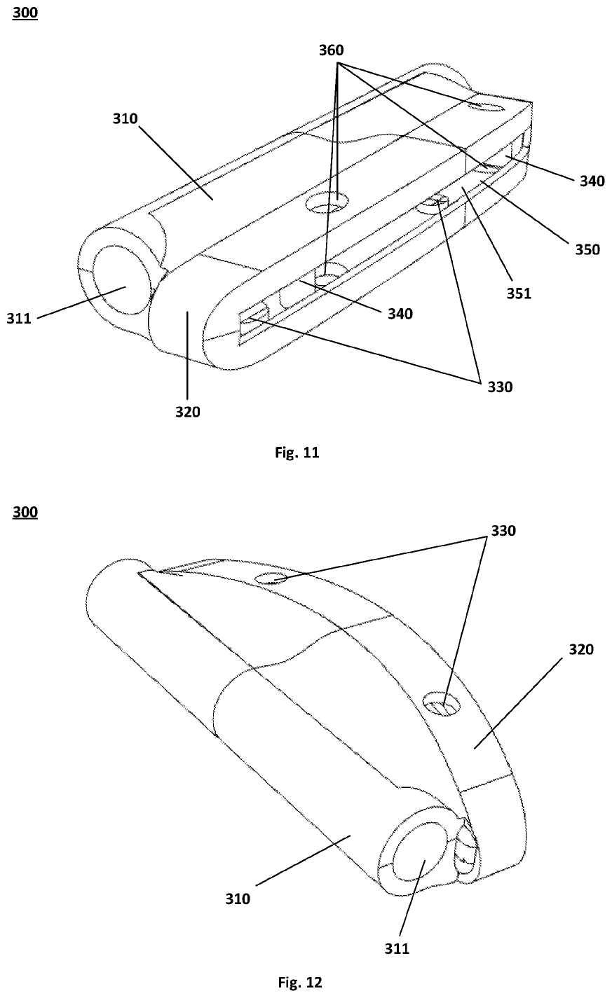

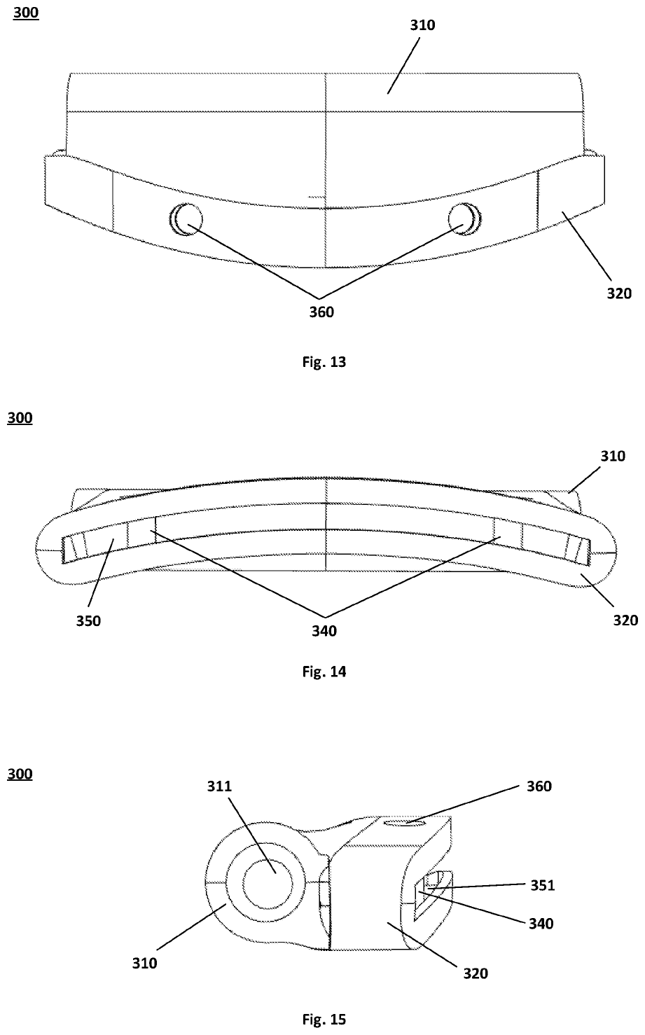

FIGS. 11-15 depict second component 300 having an extension portion 310 and an engaging portion 320. Engaging portion 320 defines a cavity 350 and holes 360, and includes columns 340. The curved shape of engaging portion 320 corresponds to the curved shape of first component 200. Cavity 350 is configured to encompass first component 200 and a portion of thin section 160 of woven band 100 by being overmolded over the first component. As depicted in the cross-sectional view of FIG. 2, this engagement secures second component 300 to first component 200 and woven band 100.

Columns 340 are similar to columns 220 of first component 200 except columns 340 can be configured to be received within both holes 190 of woven band 100 and holes 240 of first component 200. This engagement can ensure that both first component 200 and woven band 100 are securely engaged with second component 300.

Extensions 330 are substantially cylindrical and extends from a top surface (not shown) and bottom surface 351, opposite the top surface within cavity 350. Extensions 330 can be configured to engage with holes 250 of first component 200. In this manner, extensions 330 assists in securing second component 300 to first component 200. In other examples, there may be more or less than two extensions 330. In further examples, extensions 330 can be non-cylindrical, such as being rectangular, triangular, or the like. In a yet further example, extensions 330 can extend from only one of the top surface or bottom surface 351 within cavity 350.

Engaging portion 320 defines holes 360. Holes 360 can be configured to receive a portion of another component of band connector 1000, such as pins 230 of first component 200. This engagement between pins 230 and holes 360 can further minimize the risk of movement between first component 200 and second component 300.

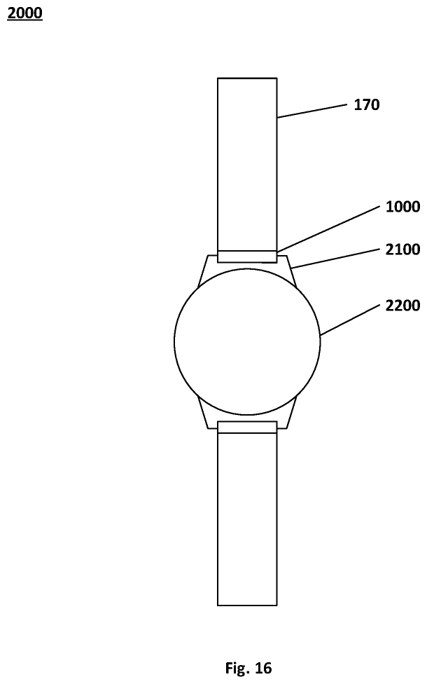

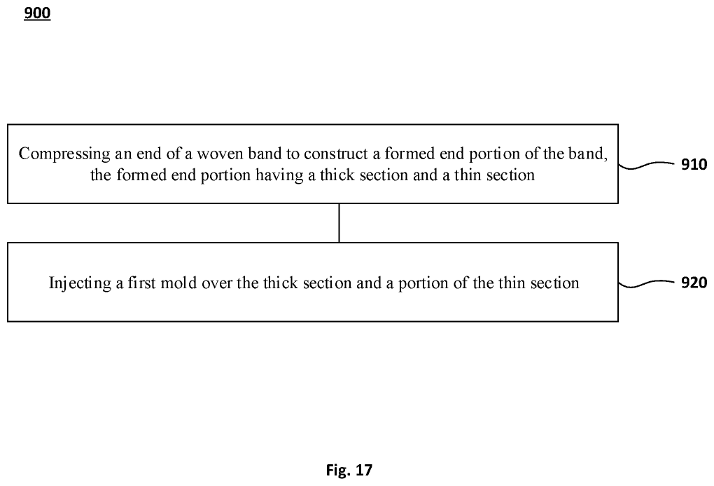

Extension portion 310 extends from engagement portion 320 and defines a channel 311. Channel 311 can be configured to receive, for example, a watch link or spring bar so that band connector 1000 can be engaged with a watch case when second component 300 is received in a space defined between the lugs of a watch case. For example, FIG. 16 depicts an example watch 2000 including band connector 1000, lug 2100, and watch case 2200. Lug 2100 can be configured to receive a link (not shown) to secure band connector 1000 to watch case 2200. The link can be received within channel 311 with ends of the link extending past second component 300 to be received in lug 2100.

With reference to flowchart 900 depicted in FIG. 17, a method of manufacturing band connector 1000 depicted in FIGS. 1-15 will now be described. An end of a woven band 100 is first prepared by cutting the woven band from a larger piece of textile using a cutting tool, such as a laser cutter, die cutting machine, or the like.

Turning to block 910, and with specific reference to FIGS. 3-4, a forming tool compresses an end of woven band 100 to form a formed end portion 180 extending from an unformed portion 170. The forming tool can be a hydraulic press, servo press, ultrasonic welding machine, or the like can be used to compress woven band 100. The forming tool may be heated. For example, the forming tool may be a heating pressing tool with a heated platten or a servo heat press. Woven band 100 can be a polymer or plastic that melts the textiles in the woven band into a solid and monolithic geometry when compressed by a forming tool applying a sufficiently high pressure and/or temperature, rather than a weaving of separate fibers as in unformed portion 170. The forming tool can additionally include a heating component to further ensure that formed end portion 180 is fully solidified by heating the end of woven band 100 during compression.

The forming tool can compress formed end portion 180 into a curved shape in both height and width. In this manner, the curved nature of formed end portion 180 can minimize translational movement between the formed end portion and additional components formed around the formed end portion, such as first component 200. In other examples, a cutting tool can cut formed end portion 180 into a curved shape.

Further, where woven band 100 has a variable cross-sectional area, a film (not shown) may be placed on the end of the woven band prior to being compressed into formed end portion 180. The film can assist in normalizing the cross-sectional area of woven band 100 and can be made of a same material as the woven band (e.g., a polymer or plastic). In this manner, the film can assist in ensuring that formed end portion 180 is a solid geometry when the end of woven band 100 is compressed. In other examples, more than one film may be used.

A cutting tool, such as a hot knife, a machining tool, or the like, can cut a plurality of holes 140, 190 out of formed end portion 180. These holes 140, 190 can assist in aligning an injection molding tool in later stages of manufacturing and/or enable for a material, such as molded resin, to be inserted within the holes to ensure a more secure connection between formed end portion 180 and parts engaged with the formed end portion.

An injection molding tool can then align and engage with formed end portion 180. For example, an injection molding tool can engage with holes 140 to ensure that the injection molding tool is correctly aligned with formed end portion 180. Once the injection molding tool is aligned with formed end portion 180, turning to block 920 and with specific reference to FIGS. 5-10, a first component 200 is injected over thick section 150 and a portion of thin section 160. This can include injecting a portion of first component 200 into holes 140 to form columns 220 to ensure a more secure engagement between first component 200 and woven band 100.

First component 200 can be formed over at least portion of formed end portion 180 such that thick section 150 and a portion of thin section 160 is encompassed within cavity 210. In this manner, thick section 150 can be fully surrounded by first component 200 to further minimize the risk of movement and/or delamination between the first component and woven band 100. The injection molding tool can form first component 200 to be curved so that the risk of movement and/or delamination between the first component and additional components formed over the first component can be minimized.

The injection molding tool can form first component 200 to define holes 240, 250 on a top surface and a bottom surface of the first component. Where holes 190 are cut into formed end portion 180, holes 240 can be formed to align with holes 190. In this manner, a portion of an additional component may be injected into holes 190, 240 to better secure all components of band connector 1000. Holes 250 can be formed to allow for an injection molding tool to better align and engage with first component 200 where further manufacturing may be required.

The injection molding tool can form pins 230 to extend from a top surface and bottom surface of first component 200. Similar to holes 250, pins 230 can assist an injection molding tool in aligning and engaging with first component 200. For example, pins 230 can be received in a portion of the injection molding tool when the tool engages with first component 200.

Once first component 200 has been formed, an injection molding tool can align and engage with the first component. For example, the injection molding tool can engage with holes 250 and pins 230 to ensure that the tool is properly aligned with first component 200. With specific reference to FIGS. 9-14, an injection molding tool can then overmold a second component 300 over first component 200. Second component 300 can be formed to have an extension portion 310 and an engaging portion 320.

The injection molding tool can form a number of features from engaging portion 320 to ensure a secure engagement between second component 300 and first component 200. Engaging portion 320 can be formed to receive first component 200 within cavity 350 so that the first component is fully encompassed by the second component. Where, holes 190, 240 have been respectively formed in woven band 100 and first component 200, columns 340 can be injected to extend between a top and bottom surface in cavity 350 within the holes to further secure second component 300 with the first component and the woven band. The engagement between first component 200 and second component 300 can be further secured by extension 330 being injected to extend from a top and bottom surface of cavity 350 within holes 250 of first component 200. Further, holes 360 can be formed to receive pins 230 extending from first component 200 to similarly achieve a better engagement between first component 200 and second component 300.

The injection molding tool can form extension portion 310 to define a channel 311 so that a component, such as a watch link or spring bar, can be received within the channel. For example, with specific reference to FIG. 16, a link (not shown) can secure band connector 1000 with lug 2100 and watch case 2200.

In other examples, second component 300 may be directly overmolded onto formed end portion 180 without forming first component 200. In this manner, manufacturing band connector 1000 can have one less step and be reduced in complexity, thus saving time and resources.

Band connector 1000 provides a stronger connection between a watch case and a watch band than prior connection methods. The geometry of formed end portion 180 enables for an injection mold tool to more efficiently engage with woven band 100 and for components to be optimally injection molded over the formed end portion. Further, the geometry of formed end portion 180 provides a more secure connection between those components and woven band 100. Moreover, using an injection molding process to form first component 200 and second component 300, including using the alignment features of each component to properly align the injection molding tools with the molds, decreases the time and complexity in manufacturing band connector 1000. Such a manufacturing process of band connector 1000 enables for a more complex woven band 100 to be used, including a woven band with a high degree of cross-sectional variability.

Although the subject matter herein has been described with reference to particular examples, it is to be understood that these examples are merely illustrative of the principles and applications of the subject matter described. It is therefore to be understood that numerous modifications may be made and that other arrangements may be devised without departing from the spirit and scope as defined by the appended claims.

1. A band comprising:
a first portion comprising a plurality of fibers;
a second portion extending from an end of the first portion, the second portion having a thick section and a thin section; and
a first component encompassing the thick section and a portion of the thin section.

2. The band of claim 1, wherein the first portion has a non-uniform cross-section.

3. The band of claim 1, wherein the first portion and the second portion are a same material.

4. The band of claim 1, wherein the second portion further includes a film having a same material as the first portion.

5. The band of claim 1, wherein the thin section extends from the end of the first portion.

6. The band of claim 1, wherein the thick section defines a plurality of holes along a length of the thick section.

7. The band of claim 1, further comprising a second component encompassing the first component.

8. The band of claim 7, wherein the first component includes a protrusion extending in a direction substantially perpendicular to a longitudinal axis defined by the band.

9. The band of claim 7, wherein the second portion defines a first hole and the first component defines a second hole, the first hole being concentric with the second hole.

10. The band of claim 7, wherein the second component is configured to be engaged with a lug of a watch case.

11. A method for forming a connector on a band comprising:
compressing an end of the band to construct a formed end portion of the band, the formed end portion having a thick section and a thin section; and
injecting a first component over the thick section and a portion of the thin section.

12. The method of claim 11, further comprising heating the end of the band.

13. The method of claim 11, further comprising cutting off an excess portion of the formed end portion such that the formed end portion has a curved shape.

14. The method of claim 11, wherein forming the formed end portion includes forming the thin section extending from an unformed portion of the band.

15. The method of claim 14, wherein forming the formed end portion includes forming the thick section extending from the thin section.

16. The method of claim 11, further comprising injecting a second component over the first component.

17. The method of claim 16, further comprising ensuring alignment over a protrusion extending from the formed end portion.

18. The method of claim 16, further comprising:
cutting a first hole in the formed end portion and a second hole in the first component;
aligning the first hole and the second hole; and
injecting a portion of the second component into the first hole and the second hole.

19. The method of claim 11, further comprising laying a film over the end of the band.

20. The method of claim 19, wherein compressing the end of the band includes compressing the film over the formed end portion.
